(19) United States
(12) Patent Application Publication
(10) Pub. No.: US 2008/0010392 A1
(43) Pub. Date: Jan. 10, 2008

(54) SYSTEM, METHOD AND COMPUTER PROGRAM PRODUCT FOR DISTRIBUTED PROCESSING OF MULTIMEDIA CONTENTS IN COMMUNICATION NETWORKS

(75) Inventor: Diego Melpignano, Agrate Brianza (IT)

Correspondence Address: HOGAN & HARTSON LLP, ONE TABOR CENTER, SUITE 1500, 1200 SEVENTEENTH ST, DENVER, CO, 80202, US

(73) Assignee: STMICROELECTRONICS S.R.L., AGRATE BRIANZA (IT)

(21) Appl. No.: 11/752,070

(22) Filed: May 22, 2007

(30) Foreign Application Priority Data
Jul. 6, 2006 (IT) TO2006A000500

(51) Int. Cl. G06F 13/36

(52) U.S. Cl. 710/117

(57) ABSTRACT

A system for distributed processing of multimedia contents includes a plurality of microprocessor devices associated with one or more communication networks. Each device includes one or more components able to process said multimedia contents according to the requirements of one or more applications forwarded through at least one of the devices comprising a MultiMedia Framework for managing processing of multimedia contents. The MultiMedia Framework includes an application-programming interface. At least one of the devices includes one or more agent modules which can operate according to a service-discovery protocol for publishing on the communication network in a manner accessible to the application-programming interface, to components supported locally by one or more of the devices and to components supported by devices arranged remotely on the communication network.

### RELATED APPLICATION

The present application claims priority of Italian Patent Application No. T02006A000500 filed Jul. 6, 2006, entitled SYSTEM FOR DISTRIBUTED PROCESSING OF MULTIMEDIA CONTENTS IN COMMUNICATION NETWORKS, IN PARTICULAR HOME NETWORKS, AND CORRESPONDING METHOD AND COMPUTER PROGRAM PRODUCT, which is incorporated herein in its entirety by this reference.

### FIELD OF THE INVENTION

The present invention relates to systems and methods for distributed processing of multimedia contents in communication networks, in particular home networks, there being connected on said communication networks devices comprising components suitable for processing multimedia contents. Even though the present invention will be described in what follows with particular reference to multimedia components that support a UPnP (Universal Plug-and-Play) protocol, it is clear that the invention in any case extends its applicability to all architectures and components that have protocols compatible with the system and method according to the invention.

### BACKGROUND OF THE INVENTION

The sort of digital apparatuses that may so far be found in a domestic or community environment are increasingly based upon the adoption of processors containing central processing units (CPUs) of a programmable type. Said CPUs frequently present a very significant computation power. However, in the majority of cases, the devices incorporated in said apparatuses exploit only a minimal part of said computation power and few, or only one, of the specific functions that the processors are able to perform, with the result that said systems can be regarded as closed systems.

On the other hand, also in the domestic field, communication networks are now available that connect different devices, such as personal computers (PCs), digital cameras, stereo systems, set-top boxes, and television sets. Said home networks use technologies such as Wireless LAN, Ultra Wide Band, Ethernet and HomePlug to render interconnection of devices simple for the user, whilst protocols based upon the Internet Protocol, such as the UPnP protocol, enable the different devices to know the respective capacities and functions and be controllable in a remote manner.

Consequently, the introduction of said home communication networks and said protocols enables connection of digital apparatuses and their inter-operability for the purpose of sharing resources thereof, such as the computation power of the processors.

Known, for example, from the publication by N. Wang et al. “Towards an Adaptive and Reflective Middleware Framework for QoS-enabled CORBA Component Model Applications”, Distributed System on line special issue on Reflective Middleware, is a system for distributed processing of multimedia contents based upon the CORBA (Common Object Request Broker Architectures) standard. In such a context, which is not oriented to the processing of multimedia contents, the components of different devices interact with one another only through so-called “remote procedures”. This proves disadvantageous in environments of an ‘embedded’ type, since it introduces a significant complexity in the implementation. Furthermore, the CORBA standard has a limited diffusion in commercial products.

In general, it is in any case known, in multimedia devices such as PCs, mobile phones, or palm-top devices, to use a multimedia infrastructure, which is basically a software structure (usually a set of software libraries) for managing the multimedia contents in a processor system and through a network. Said multimedia infrastructure is usually referred to as ‘MultiMedia Framework’, a term that will be used in the sequel of the present description in so far as it is normally adopted in the technical field referred to herein and recognized by ISO in connection, for example, with video standards, such as the MPEG standard (for example, MPEG-21 ISO/IEC TR 2100-1:2004). A MultiMedia Framework usually comprises an Application-Program Interface (API) and a modular architecture for adding in a simplified way new coders/decoders (codecs) and container formats. It is intended for use in applications such as media players and audio or video editors. Numerous examples of MultiMedia Frameworks are known, such as Symbian MMF, Microsoft DirectShow, and Linux Gstreamer.

In the U.S. patent application No. 2004/0034622 it is disclosed a method for authoring and communication of multimedia contents in a communication platform of multimedia objects. Said method makes use of a Document Type Definition (DTD) model and documents in Extensible Markup Language (XML) created according to said DTD model for describing multimedia contents and their behaviour in dynamic multimedia communications. A player of multimedia contents is able to read the DTD model and the XML document to reproduce the multimedia content. A solution of the sort requires design of the player as stand-alone application.

U.S. Patent Application Publication No. 2002/0116545 discloses systems of distributed processing for communication networks that make use of middleware comprising an API modelled on model data that describe parameters of quality of service required by given mobile multimedia applications. Said systems define, however, the parameters only at the application level.

Consequently, the known solutions do not enable complete exploitation of the resources of devices available on the home network, nor do they avail themselves fully of the computation power available thereon in so far as, in general, said devices are closed systems, and there is no way to access the majority of the functions of each device available on the home network.

### SUMMARY OF THE INVENTION

The aim of the present invention is to overcome the drawbacks mentioned above and to propose a solution that will enable more extensive exploitation of the resources of devices available on a communication network, particularly a home network, and fuller exploitation of the computation power available thereon, accessing the majority of the functions of the device.

In accordance with the present invention, the above purpose is achieved by means of a system having the characteristics recalled in the annexed claims, said claims forming an integral part of the technical teaching regarding the invention. The present invention also relates to a corresponding method, as well as a computer program product directly loadable into the memory of at least one computer and comprising software code portions for performing the aforesaid method. As used herein, the reference to such a computer program product is understood as being equivalent to reference to a computer-readable medium containing instructions for controlling a computer system in order to co-ordinate execution of the method according to the invention. The reference to “at least one computer” is aimed at highlighting the possibility for the present invention to be implemented in a distributed and/or modular way.

### BRIEF DESCRIPTION OF THE DRAWINGS

The invention will now be described, by way of non-limiting example, with reference to the figures of the annexed drawings, in which.

FIG. 1 illustrates a block diagram of principle of operation of a system according to the invention;

FIG. 2 illustrates a more detailed block diagram of the system of FIG. 1;

FIG. 3 illustrates a diagram representing signals used in the system according to the invention; and

FIG. 4 illustrates a block diagram of an embodiment of the system according to the invention.

### DETAILED DESCRIPTION OF PREFERRED EMBODIMENTS

In brief, the system and method proposed enable a MultiMedia Framework to access the functions of remote components in a transparent manner, i.e., as if they were present in the local device.

There is hence proposed a system that extends the concept of MultiMedia Framework, or multimedia infrastructure, typically used for connecting audio/video components within a device, to a home network, in particular to applications of a streaming type, but also to real-time applications, such as video-telephony or Voice-over-IP. According to the invention, it is envisaged that individual devices notify the multimedia components supported thereby through a service-discovery protocol, in a preferred embodiment the UPnP protocol. In this way, a multimedia application can be set by a controller, in particular through an API, conveniently integrated through the connection of components that are physically located in different apparatuses.

MultiMedia Frameworks are, as has been said, usually employed within a single device for connecting components, such as input/output ports, coders, decoders, mixers, for the purpose of implementing complex applications. The infrastructures represented by the MultiMedia Framework enable management of different kinds of media, amongst which audio, video and images.

The multimedia components manipulate data buffers that contain multimedia data transmitted at high rates, consequently requiring optimized data paths. Beyond this, descriptive metadata of the content of the data buffers can be extracted from or introduced into said components.

MultiMedia Frameworks enable the components to be instantiated, configured and connected together for implementing a specific application. In the present description, by “instantiation” is meant the operation of creation of objects with corresponding allocation of memory and initialization of fields, as is known from object programming, for example, Java programming.

As has been said, the system proposed herein extends said traditional and known concept of MultiMedia Framework, in so far as it enables a single device to create a multimedia application through the connection of components that are physically located in multiple devices connected to it through one or more communication networks. All this is obtained without having to change or modify the MultiMedia Framework and the applications that use the services thereof.

The system of distributed processing of multimedia contents proposed envisages:
discovering which components are available within the communication network;
creating a graph of components, where some of them belong to the same device, whilst other components are physically separate;
in the case where two components associated with different devices are to be connected, ensuring that the communication network supports the bit-rate and the quality of service (QoS) required;
instantiating network transmitters and receivers to set-up data connection between components through the communication network; and
controlling the state of the local or remote components.

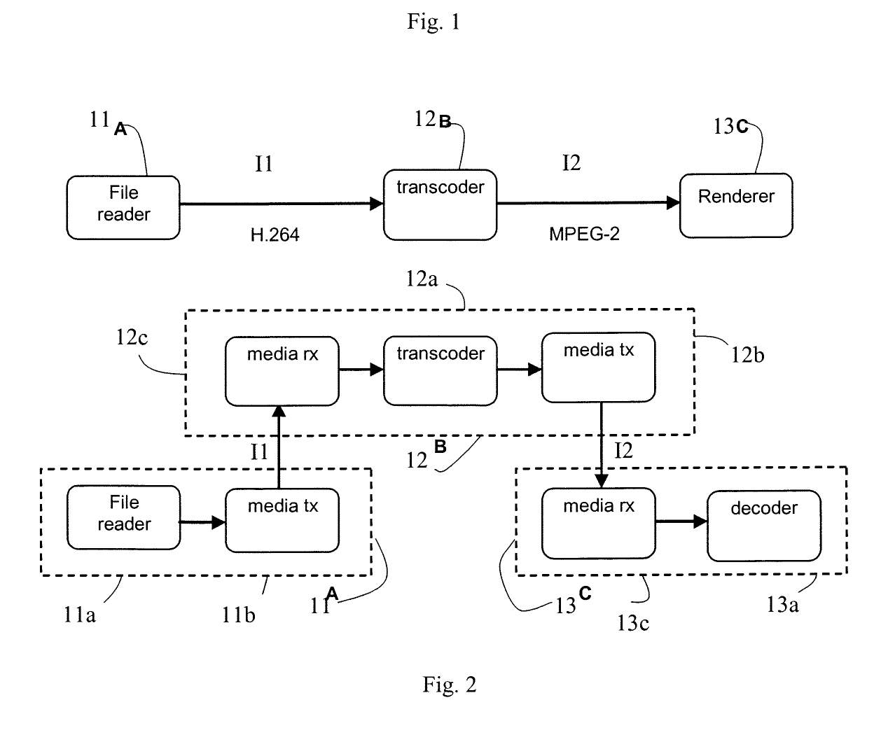

FIG. 1 represents a block diagram of principle of operation of a system according to the invention, designated as a whole by the reference number 10.

Designated by the reference number 11 is a block representing a first device connected on a communication network 20. Said first device 11 sends a multimedia content I1 on the communication network 20 to a second device 12, which carries out a processing on the multimedia content I1, obtaining the multimedia content I2, which is transmitted on said communication network to a third device 13, which is able to carry out a further processing, i.e., reproduce the multimedia content I2.

The first device 11 can be a mobile phone which requests display of a recorded video film, the multimedia content I1, on a television set. The video film is recorded on the mobile phone 11, using a video compression standard MPEG4 or H.264. However, the television set, of a digital type, accepts, instead, preferably video films in MPEG2 format, corresponding in FIG. 1 to the information content I2. It is therefore necessary to perform an operation of transcoding of the video film from the H.264 standard to the MPEG2 standard.

Given the high computational complexity of the transcoding function, neither the mobile phone 11 nor the television set 13 would be able to carry said function. However, using a home PC as second device 12 it is possible to execute said transcoding operation provided that a component suited for executing said operation is present within said PC.

According to the invention, the distributed-processing system 10 envisages that the first device 11, i.e., the mobile phone, implements procedures that can discover the transcoding component in the PC corresponding to the second device 12 and create a graph equivalent substantially to the block diagram of FIG. 1. It is clear that, by “operation of creation of a graph” is meant the generation of schemes, with the corresponding instantiations of objects for connection between components viewed in terms of nodes and lines according to graph theory.

The mobile phone 11 consequently sees a list of multimedia components published as available on the communication network 20. However, said mobile phone 11 also requires verification of whether the communication between the input ports and output ports of the components is possible. The mobile phone 11 is hence able to create a complete graph, which is illustrated via the block diagram of FIG. 2.

FIG. 2 consequently illustrates a graph in which, comprised in the first device 11, i.e., the mobile phone, is a file reading component 11a, i.e., a component for reading video corresponding to the information content I1, and a media transmitter 11b for transmitting the information content I1 is hence instantiated. Instantiated in the second device 12, i.e., the PC, is a corresponding media receiver 12c, i.e., a receiver, which is suited to receiving the information content I1, which, in the example illustrated herein, is in H.264 format, and uses the same communication protocol as the one used by the media transmitter 11b, for example a streaming protocol, such as HTTP on TCP/IP, as well as a media transmitter 12b for transmitting the information content I2, i.e., the video in MPEG2 format generated by the transcoding component 12a. The media transmitter 12b is ideally configured so as to enable the third device 13, i.e., the digital television set, to receive, via a corresponding media receiver 13c, the information content I2, decode it via a decoding component 13a and finally present the decoded video on the screen. The protocol for communication between the second device 12 and the third device 13 may also be different from the one used between the first device 11 and the second device 12, according to the capacity of the device or of the network. For example, the first device 11, as mobile phone, can use a Bluetooth Obex protocol for transferring the information content I1 to the second device 12, i.e., the PC, whilst the PC can stream the information flow to the third device 13, i.e., the television set, via HTTP/TCP/IP or RTP/UDP/IP.

In the context of the UPnP protocol, which is described in an on-line publication titled “Understanding UPnP” at http://www.upnp.org/resources/whitepapers.asp, and in the publication M. Jeronimo, J. Weast, “UPnP design by example: a software developers' guide to Universal Plug 'n Play”, Intel Press, ISBN0971786119, the service-discovery operations usually envisage that the devices export entire applications through their publication on the communication network. In the system according to the invention it is instead envisaged to render the components of the applications available, with a consequently higher level of detail, so that it will be possible to build complex distributed applications, combining components coming from different devices, under the control of any Control Point device, for example a Control Point device in the context of the UPnP protocol.

In practice, the list of the multimedia components published available on the communication network 20 can be gathered by any Control Point and presented in a MultiMedia Framework as if the components were all local.

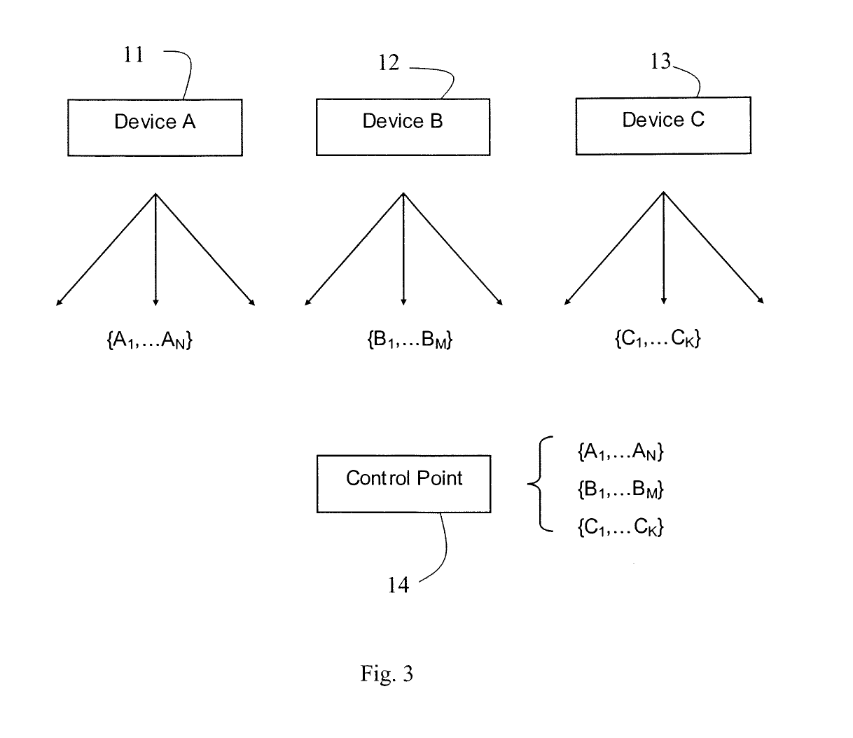

FIG. 3 is a schematic illustration of just such a situation, in which the first device 11 publishes its own components A1, . . . , AN, whilst the second device 12 publishes second components B1, . . . , BM, and the third device 13 publishes third components C1, . . . , CK, which appear published at a Control Point 14 for use by the MultiMedia Framework.

An application, which is run, for example, on the first device 11, can consequently use the MultiMedia Framework at this degree of detail, i.e., on the basis of the list of components available at the Control Point 14, which can be accessed to create the desired graph of components.

Elements necessary to enable connection between ports of remote components can be instantiated automatically by the MultiMedia Framework, without the application thereof being informed.

Within the system for distributed processing of multimedia contents according to the invention, a first important aspect requires taking into account the fact that the components are associated with input ports and/or output ports, through which the data buffers are exchanged. The connection of components in the graph created by the MultiMedia Framework corresponds in effect to a connection between ports of said components, which are ideally homogeneous, i.e., they must deal with buffers that transport the same type of data.

A second important aspect of the distributed-processing system regards control of the components. The components are ideally configured by an application that makes use thereof at the moment of initialization; however, it is possible to modify the parameters in runtime.

This is usually obtained within the MultiMedia Framework by means of complex data structures that bear the parameters important for performing the configurations of the components according to the multimedia domain (audio, video, images, graphic, etc.). With reference to the system described in FIGS. 1 and 2, an example of configuration parameter can be represented by the output bit-rate of the transcoder component 12a.

In order to define a standard mode of presenting the configuration of the component, it is envisaged in the system and method proposed to resort to the service-discovery function of the UPnP standard, which represents the component configuration by means of XML documents. Since the UPnP service-discovery function provides only a standard mode of representing the information, but does not define the parameters necessary for configuring the components, the system according to the invention envisages using preferably as reference for said definition the Khronos OpenMAX Integration Layer API (hereinafter IL API) in so far as said interface enables extensive application in a large number of platforms.

For an illustration of said standard, see, e.g., “OpenMAX—the standard for media library portability”, available at http://www.khronos.org/openmax/.

It is then to be noted that, in the context of devices that can process multimedia contents connected to a communication network there are ideally distinguished at least two categories of components: components that have a local meaning; and components that do not have a local meaning.

For example, for an audio/video-player component, the position within the communication network or within the environment in which said communication network is displayed is of some importance. Consider, for example, a television set in a lounge or in the kitchen. Conversely, a transcoder component can be positioned anywhere within the home communication network, provided that it performs the functions required of it.

As regards the components the physical location of which within the network is important from the applicational standpoint, it is consequently possible to adopt, in the context of the system proposed, a convention that will identify the position thereof, for example using the name of the component. In this way, a component of a “renderer” type, for example, a video display, such as the television set 13, located in the lounge, could be referred to as “OMX.ST.Video.Renderer.Lounge”, using a syntax of the type defined for the Khronos OpenMAX IL API. The creation of the name of the component that will include also its location is the responsibility of the IL core of the API 113. It is possible to associate the function of the component to its position, thanks to the service-discovery protocol, on the hypothesis that the remote devices render this information available. This could require a procedure of configuration assisted by the user in the installation stage. It is clear that, once this information on the location of the component is made available to the MultiMedia Framework through the standard IL API 113, the applications can draw immediate benefit therefrom.

The distributed MultiMedia Framework proposed can be applied to many different systems, from PCs to mobile phones or to set-top boxes.

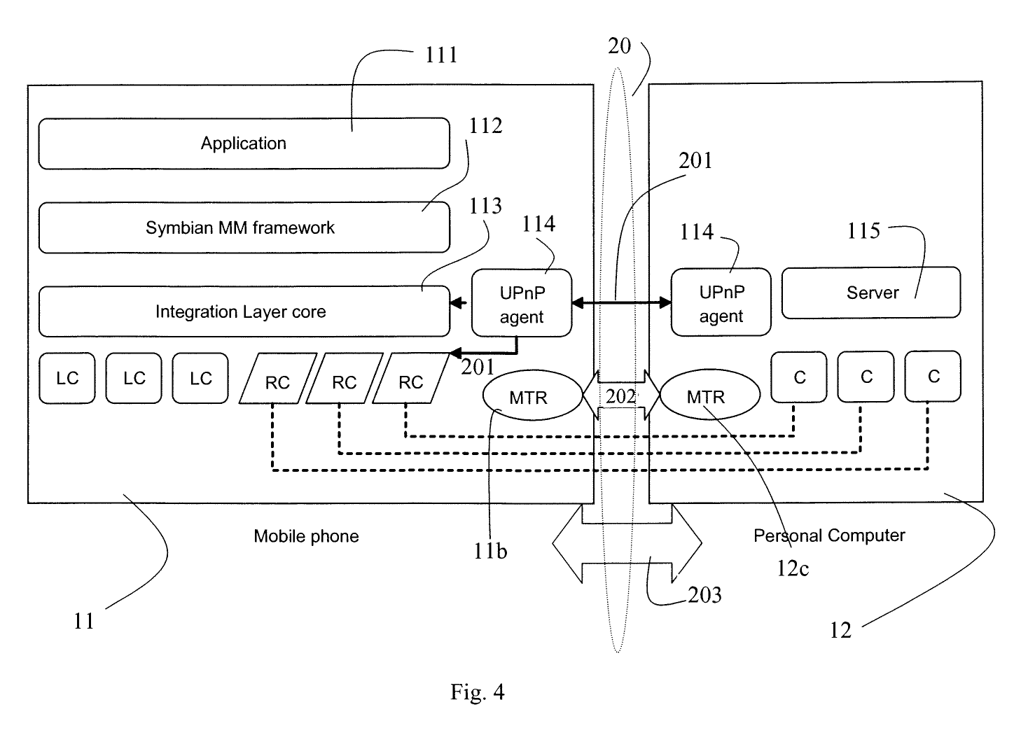

For example, in a mobile phone, traditional MultiMedia Frameworks, such as Symbian MMF/MDF, are evolving towards the support of the OpenMAX standard, in which local multimedia components can be controlled through the aforementioned IL API. As illustrated in the diagram of FIG. 4, which details one embodiment of the present invention, it is envisaged in a mobile phone 11 to provide an implementation with IL API 113, where the set of components that the MultiMedia Framework can use is variable and also includes remote components, identified through a service-discovery procedure, based upon the IP, in particular according to the UPnP protocol, on the communication network 20. The mobile phone 11 consequently comprises blocks representing levels corresponding to an application 111, to a MultiMedia Framework 112, and to the API 113. The IL API enables control of a set of basic elements referred to as components. Implementation of the IL API moreover comprises a core referred to as “IL core”, which manages instantiation of the components and direct connection between their ports (“data tunnelling”).

The API 113 according to the Khronos OpenMAX Integration Layer standard enables control and connection of multimedia components, especially for platforms that offer hardware acceleration for multimedia contents.

Designated by LC in FIG. 4 are the local multimedia components, ones belonging, that is, to the mobile-phone device 11, whilst designated by RC are proxy components, as will be more fully illustrated in what follows, i.e., components that represent remote components C present in other devices that communicate on the communication network 20.

Within said API 113 it is hence envisaged to define data structures for component configuration for each type of component in the various Audio, Video, and Imaging domains. It is moreover envisaged to set conventions for passage of the data buffers and to define the connections between the ports of the components, said operation being also in itself known and defined as “data tunnelling” in the OpenMAX standard. For example, the data tunnel can be set so that the output data buffer of a component is passed directly to the input port of the next component in the processing chain. The operation of data tunnelling in the system and method according to the invention must also take into account the connections with remote components, this not being envisaged by the API 113 in its basic configuration of OpenMAX IL API. In this case, the data buffers are ideally passed through the communication network 20 that connects the devices. To do this suitable communication protocols are ideally used, such as HTTP/TCP/IP or RTP/UDP/IP. A high-bandwidth path (HBP) 202 between the components is then made available through the media receiver 12c and the media transmitter 11b, respectively located in the PC 12 and in the mobile phone 11, which can be obtained via client-server software that operates in the network nodes. In this connection, designated by 115 in the PC 12 is the server level that exchanges data with the application level 111 in the mobile phone 11. When a data tunnel is created between two components not resident on the same device, an HBP 202 is created; i.e., all the resources necessary for transport of the data buffers between the ports of the components are to be instantiated, possibly taking into account the QoS requirements for the data that are to be transported. The management of the resources necessary for proper operation of the HBP 202 is performed by the IL core, i.e., the software library that implements the IL API.

Consequently, when remote multimedia components C are discovered in the communication network 20, for example through the UPnP service-discovery protocol, which in FIG. 4 is symbolized by the arrows with thicker black line 201, a UpnP agent module 114 in the mobile phone 11 interacts with the IL core 113, the use of which is integrated with the UPnP service-discovery protocol and is therefore transparent to the MultiMedia Framework that uses the IL API, in order to present said remote components C as if they were local. By way of example of how said integration operates, when the mobile phone 11 seeks a transcoding component, the IL core of the interface 113 receives from the MultiMedia Framework a call of the OMX_GetHandle type, in itself known within the OpenMAX IL standard, which identifies the component specified through the name attributed to the component, loads the component into the memory, and validates it. In the system according to the invention, said OMX_GetHandle function is made to operate, to execute identification of the component, on the object constituted by the list of components published by the UPnP service-discovery protocol, for example the list of components accessible to the Control Point 14 of FIG. 3.

In this way, the MultiMedia Framework 112, which does not require modifications, can make use both of the local components LC and of the remote components C. In particular, as has been said, the blocks designated by RC in FIG. 4 are proxy for the real remote components C, which, in the example illustrated, are located in the PC 12.

Whenever a function call belonging to the standard of the API 113 is invoked on a proxy RC of the remote component, it is ideally sent to the corresponding remote component C for execution. In the case of a configuration command, this is, for example, translated into a SOAP (Simple Object Access Protocol) message 203, whilst the data-passage functions use the HBP 202 made available through the media transmitters and receivers lib and 12c. For this purpose FIG. 4 as a whole represents by means of a dashed ellipse the communication network 20, which supports the UPnP procedure 201, the HBP 202 and the SOAP messages 203.

Consequently, without prejudice to the principle of the invention, the details of construction and the embodiments may vary, even significantly, with respect to what is described and illustrated herein purely by way of non-limiting example, without thereby departing from the scope of the invention, as defined in the ensuing claims.

For instance, it is possible to use as procedure designed to discover components on the network, instead of the UPnP standard, other protocols defined by IETF, such as the Service Location Protocol (SLP).

1. A system for distributed processing of multimedia contents, said system comprising:
a plurality of microprocessor devices associated with one or more communication networks, each of said devices comprising one or more components, which are able to process said multimedia contents according to the requirements of one or more applications forwarded through at least one first from among said one or more devices comprising a MultiMedia Framework for managing processing of multimedia contents, said MultiMedia Framework in turn comprising an application-programming interface, wherein one or more devices comprise one or more agent modules, which can operate according to a service-discovery protocol for publishing on said communication network in a manner accessible to said application-programming interface components supported locally by said one or more devices and components supported by devices arranged remotely on said communication network.

2. The system according to claim 1, wherein said application-programming interface is configured for creating, on the basis of said application requiring distributed processing, a connection and control graph between said components supported locally by said one or more devices and said components supported by remote devices.

3. The system according to claim 1, wherein said one or more agent modules are able to publish on said communication network a list of the components available on the communication network in a way accessible to functions of component location of said application-programming interface.

4. The system according to claim 1, wherein said application-program interface comprises an OpenMax Integration Layer API.

5. The system according to claim 1, wherein said service-discovery protocol comprises a UpnP (Universal Plug-And-Play) protocol and is integrated with a core of said interface Openax IL API to enable said MultiMedia Framework to access the functions of remote components in a transparent way.

6. The system according to claim 3, wherein said UPnP service-discovery protocol comprises at least one Control Point for gathering said list of the published components available on the communication network.

7. The system according to claim 1, wherein said service-discovery protocol comprises a Service Location Protocol or other equivalent protocol.

8. The system according to claim 1, wherein said one or more agent module, which are able to operate according to a service-discovery protocol for publishing on said communication network in a way accessible to said application-programming interface, are configured for publishing said multimedia components supported by remote devices as if they were local ones.

9. The system according to claim 2, wherein said application-program interface is configured for creating said connection and control graph instantiating network transmitters and/or network receivers to establish the connection of data between local components and remote components through the communication network.

10. The system according to claim 9, wherein said network transmitters and/or network receivers are instantiated to establish the connection of data between input ports and/or output ports, through which data buffers are exchanged.

11. The system according to claim 10, wherein said application-program interface is configured for data tunnelling between the ports of the local components and the ports of the components supported by remote devices by said network transmitters and/or network receivers.

12. The system according to claim 9, wherein said network transmitters and/or network receivers are configured for setting a high-bandwidth path on the communication network between the local components and the components supported by remote devices.

13. The system according to claim 12, wherein said high-bandwidth path is set taking into account the requirements of Quality of Service for the data to be transported.

14. The system according to claim 9, wherein said application-program interface is configured for setting the network transmitters and network receivers so that the corresponding ports are homogeneous with respect to the type of data treated.

15. The system according to claim 7, wherein said agent module is configured for presenting said components supported by remote devices via proxy components created on said device.

16. The system according to claim 1, configured for exchanging parameters of configuration of the components between the devices associated with said communication network by a UpnP service-discovery procedure and XML documents.

17. The system according to claim 16, configured for defining the parameters necessary for configuring the components according to the reference of the application-programming interface Khronos OpenMAX Integration Layer API.

18. The system according to claim 1, configured for exchanging parameters of configuration of the components between the devices associated with said communication network via SOAP (Simple Object Access Protocol) messages.

19. The system according to claim 1, wherein said communication network comprises a network selected in the group comprising Wireless LAN, Ultra Wide Band, Ethernet and HomePlug.

20. The system according to claim 1, wherein said first device comprises a mobile phone.

21. The system according to claim 3, wherein said list of the components available on the communication network comprises positions of the components.

22. A method for distributed processing of multimedia contents in one or more communication networks, associated with which is a plurality of devices comprising one or more components, which comprises the operations of processing said multimedia contents by said one or more components according to the requirements of one or more applications forwarded through at least one first from among said one or more devices, said processing comprising provision of a MultiMedia Framework including an application-programming interface, wherein published on said communication networks in a way accessible to said application-programming interface is a list of the components supported locally by said one or more devices and of the components supported by devices arranged remotely on said communication network, said publishing comprising execution, in said one or more devices, of respective agent procedures operating according to a service-discovery protocol.

23. The method according to claim 22, wherein there is created, on the basis of said application requiring distributed processing, a connection and control graph between said components supported locally by said one or more devices and said components supported by devices arranged remotely.

24. The method according to claim 22 further comprising publishing, on said communication network, said list of the components available on the communication network in a manner accessible to functions of component location of said application-programming interface.

25. The method according to claim 22, wherein said application-program interface comprises a Khronos OpenMax Integration Layer API.

26. The method according to claim 22, wherein said service-discovery protocol comprises a UPnP protocol and is integrated with a core of said interface OpenMax Integration Layer API to enable the MultiMedia Framework to access the remote components in a transparent manner.

27. The method according to claim 25, wherein said UPnP service-discovery protocol comprises a Control Point for gathering said list of the multimedia components published available on the communication network.

28. The method according to claim 22, wherein said service-discovery protocol comprises a Service Location Protocol.

29. The method according to claim 22, wherein publishing on said communication network comprises publishing said components supported by remote devices as if they were local.

30. The method according to claim 22, wherein creating a connection and control graph on the basis of said application requiring distributed processing comprises instantiation of network transmitters and/or network receivers to establish the data connection between local components and remote components through the communication network.

31. The method according to claim 30, wherein creating a connection and control graph comprises instantiation of said network transmitters and/or network receivers to establish the data connection between input ports and/or output ports, through which data buffers are exchanged.

32. The method according to claim 30, wherein creating a connection and control graph comprises data tunnelling between the ports of the local components and the ports of the components supported by remote devices by said network transmitters and/or network receivers.

33. The method according to claim 30, wherein creating a connection and control graph comprises setting a high-bandwidth path on the communication network between the local components and the components supported by remote devices by said network transmitters and/or network receivers.

34. The method according to claim 33, wherein resources of said high-bandwidth path are set taking into account requirements of Quality of Service for the data to be transported.

35. The method according to claim 33, wherein the network transmitters and network receivers are set so that the corresponding ports are homogeneous.

36. The method according to claim 29, further comprising presenting said components supported by remote devices via proxy components created on said first device.

37. The method according to claim 22, further comprising exchanging parameters of configuration of the components between the devices associated with said communication network via SOAP (Simple Object Access Protocol) messages.

38. The method according to claim 22, further comprising associating a position of the component to its function in the list of the components available on the communication network.

39. A microprocessor device able to process multimedia contents and to be associated with one or more communication network, comprising:
one or more components able to process said multimedia contents according to the requirements of one or more applications, and comprising a MultiMedia Framework for managing processing of multimedia contents, which in turn comprises an application-programming interface; and
one or more agent modules which can operate according to a service-discovery protocol for publishing, on said communication network in a way accessible to said application-programming interface, a list of components supported locally by said one or more devices and components supported by devices arranged remotely on said communication network.

40. A computer program product directly loadable into the memory of at least one computer and comprising software code portions for performing a method for distributed processing of multimedia contents in one or more communication networks, associated with which is a plurality of devices comprising one or more components, which comprises the operations of processing said multimedia contents by said one or more components according to the requirements of one or more applications forwarded through at least one first from among said one or more devices, said processing comprising provision of a MultiMedia Framework including an application-programming interface, wherein published on said communication networks in a way accessible to said application-programming interface is a list of the components supported locally by said one or more devices and of the components supported by devices arranged remotely on said communication network, said publishing comprising execution, in said one or more devices, of respective agent procedures operating according to a service-discovery protocol.
